(19) United States
(12) Patent Application Publication
(10) Pub. No.: US 2025/0051678 A1
(43) Pub. Date: Feb. 13, 2025

(54) MOTOR AND GEARBOX FLUID FORMULATIONS AND USES THEREOF

(71) Applicant: Tesla, Inc., Austin, TX (US)

(72) Inventors: Scott Graves, Felton, CA (US); Wenyang Zhang, Sunnyvale, CA (US); Jiazheng Hong, Sunnyvale, CA (US); Hai Lan, Sunnyvale, CA (US); Diego A. Silva Rodriguez, Ben Lomond, CA (US); Eric Bellemare, Shefford (CA); Eric Thibault, Vancouver (CA)

(21) Appl. No.: 18/717,403

(22) PCT Filed: Jan. 5, 2023
(86) PCT No.: PCT/US2023/010203

§ 371 Date: Jun. 6, 2024

Related U.S. Application Data
(60) Provisional application No. 63/296,959, filed on Jan. 6, 2022.

(51) Int. Cl. C10M 169/04; C10M 101/02; C10M 107/02; C10N 20/02; C10N 30/02; C10N 40/00; C10N 40/04; F16H 57/04; H02K 7/116; H02K 9/193; H02K 9/26

(52) U.S. Cl. CPC C10M 169/04; C10M 101/025; C10M 107/02; F16H 57/0436; H02K 7/116; H02K 9/193; H02K 9/26; C10M 2203/1025; C10M 2205/0206; C10N 2020/02; C10N 2030/02; C10N 2040/04; C10N 2040/40

(57) ABSTRACT

Fluid formulations, including low traction fluid, low viscosity motor fluid and high pressure viscosity coefficient fluid formulations, that may be used in vehicle drive trains are described herein. The fluid formulations include a base oil and an additive. The fluid formulations may provide efficiency advantages to electric vehicle drive trains.

### INCORPORATION BY REFERENCE TO ANY PRIORITY APPLICATIONS

This application is a non-provisional of, and claims priority to, U.S. Provisional Patent Application No. 63/296,959, entitled “MOTOR AND GEARBOX FLUID FORMULATIONS AND USES THEREOF,” filed on Jan. 6, 2022, which is hereby incorporated by reference in its entirety and for all purposes.

### BACKGROUND

### Field

The present invention relates to fluid formulations. More specifically, the present invention relates to low traction and high pressure viscosity fluid formulations for automotive (e.g., electric vehicle) drive units and automotive driveline applications.

### Description of the Related Art

Fluid technology for electric vehicle motors and gearboxes is based on automatic transmission fluid formulations for traditional combustion vehicle platforms. In such platforms, the fluid formulation is optimized to satisfy wet clutch material frictional requirements and sliding wear protection. However, in certain circumstances, it is not feasible to balance gearbox requirements of gear and bearing protection, corresponding efficiency, continuous power motor and efficiency requirements, without sacrificing system efficiency and/or durability. As a result of molecular structure, traditional fluid formulations may not provide sufficient motor cooling, oxidation stability and evaporation resistance.

As such, there currently is no commercial fluid formulation that simultaneously provides high drive unit efficiency, extended fluid life, and moderate cost. Furthermore, current low traction gear oil products are not suitable for electric vehicle drive unit lubrication and cooling applications, and have issues including, but not limited to, a low pressure viscosity coefficient, hygroscopic properties, hydrolytic stability, and compatibility.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a fluid formulation is disclosed. The fluid formulation includes an additive; and a base oil, wherein the base oil is selected from the group consisting of an American Petroleum Institute (API) group II oil, an API group II+ oil, an API group III oil, an API group III+ oil, an API group IV oil, an API group V oil, and combinations thereof.

In some embodiments, the base oil is selected from the group consisting of a paraffin, a naphthene, a poly-alpha-olefin (PAO), a monoester, a di-ester, an alkylated naphthalene, a polyol ester, a polyalkylene glycol, and combinations thereof. In some embodiments, the paraffin is selected from the group consisting of an iso-paraffin, a straight chain paraffin, a cyclo paraffin, and combinations thereof. In some embodiments, the formulation comprises about 70-95 wt. % of the base oil. In some embodiments, the base oil comprises a viscosity of 1.7-2000 cSt at 100° C.

In some embodiments, the additive is selected from the group consisting of: an anti-friction additive, an anti-wear additive, an extreme pressure additive, an anti-oxidant, a corrosion inhibitor, a yellow metal deactivator, a dispersant, a detergent, a defoamer, a seal swell agent, a solvency booster, a dye, and combinations thereof. In some embodiments, the additive comprises at least one element selected from the group consisting of sulfur, phosphorous, calcium, boron, silicon, nitrogen, and combinations thereof. In some embodiments, the additive comprises an additive formulation selected from the group consisting of HiTEC 3491K, HITEC 5769, HiTEC 35750, HITEC 2571, HiTEC 4780, and combinations thereof. In some embodiments, the formulation comprises about 5-15 wt. % of the additive.

In some embodiments, the fluid formulation further includes a viscosity index improver. In some embodiments, the fluid formulation comprises about 1-20 wt. % of the viscosity index improver. In some embodiments, the viscosity index improver comprises a viscosity of about 40-20000 cSt at 100° C. In some embodiments, a viscosity of the formulation is about 2-30 cSt at 100° C. In some embodiments, a viscosity of formulation is about 300-20000 cSt at −20° C. In some embodiments, the fluid formulation is a low traction fluid formulation.

In some embodiments, a traction coefficient of the low traction fluid formulation is about 0.005-0.06. In some embodiments, a pressure-viscosity coefficient of the low traction fluid formulation is about 10-20 GPa⁻¹ at 40° C. In some embodiments, the fluid formulation is a high pressure viscosity coefficient fluid formulation. In some embodiments, a traction coefficient of the high pressure viscosity coefficient fluid is about 0.005-0.15. In some embodiments, a pressure-viscosity coefficient of the high pressure viscosity coefficient fluid is about 12-30 Gpa⁻¹ at 40° C.

In another aspect a vehicle drive unit is disclosed. The vehicle drive unit includes: a motor; a motor fluid system in fluid communication with the motor; a gearbox; and a gearbox fluid system in fluid communication with the gearbox, wherein the gearbox fluid system comprises the fluid formulation. In some embodiments, the gearbox fluid system is configured to pump fluid at a rate of about 0.2-20 LPM. In some embodiments, the motor fluid system is in fluid communication with the gearbox fluid system. In some embodiments, the motor fluid system comprises the fluid formulation. In some embodiments, the motor fluid system comprises a motor fluid formulation. In some embodiments, the motor fluid formulation is a low traction fluid formulation or a high pressure viscosity coefficient motor fluid formulation. In some embodiments, the motor is an electric motor.

In another aspect a vehicle is disclosed. The vehicle includes the vehicle drive unit. In some embodiments, the vehicle further comprises a secondary drive unit comprising a secondary fluid formulation. In some embodiments, the secondary fluid formulation comprises a secondary low traction fluid formulation or a secondary high pressure viscosity coefficient fluid formulation. In some embodiments, the gearbox fluid system of the drive unit comprises the low traction fluid formulation and the secondary drive unit comprises a secondary high pressure viscosity coefficient fluid formulation.

In another aspect, a method of using a vehicle drive unit is described. The method includes: providing a vehicle drive unit comprising: a motor; a motor fluid system in fluid communication with the motor; a gearbox; and a gearbox fluid system in fluid communication with the gearbox, wherein the gearbox fluid path system comprises the fluid formulation; and flowing the fluid formulation through the gearbox and the gearbox fluid system.

### BRIEF DESCRIPTION OF THE DRAWINGS

FIG. 1A shows a schematic depiction of a dual fluid path system design.

FIG. 1B shows a schematic depiction of a single fluid path system design.

FIG. 2 shows some drive unit efficiency enhancements of a low traction fluid formulation of some embodiments relative to that of a comparative formulation.

FIG. 3 shows drive unit efficiency enhancements of a low traction fluid formulation of some embodiments relative to that of a comparative formulation.

FIG. 4A is a graph showing tractions of fluids in some embodiments compared to comparative fluids used in drive units under a first speed and load condition.

FIG. 4B is a graph showing tractions of fluids in some embodiments compared to comparative fluids used in drive units under a second speed and load condition.

FIG. 4C is a graph showing tractions of fluids in some embodiments compared to comparative fluids used in drive units under a first sliding rolling ratio and load condition.

FIG. 4D is a graph showing tractions of fluids in some embodiments compared to comparative fluids used in drive units under a second sliding rolling ratio and load condition.

FIG. 5A is a graph showing tractions of a fluid in some embodiments compared to a comparative fluid used in drive units under a first speed and load condition.

FIG. 5B is a graph showing tractions of a fluid in some embodiments compared to a comparative fluid used in drive units under a second speed and load condition.

FIG. 6 is a graph showing pump power consumption and colder copper saving of a dual fluid path system that utilizes a low viscosity fluid and a low traction fluid in some embodiments at various flow rates.

FIG. 7 is a graph showing a motor dyno study of stator temperatures of a dual fluid path system that utilizes a low traction gearbox fluid in some embodiments at various conditions.

FIG. 8 is a graph showing the viscosities for a fluid in some embodiments compared to a comparative fluid at various temperatures.

FIG. 9 is a graph showing the viscosities and pressure viscosity coefficients (PVCs) for fluids in some embodiments.

FIG. 10A shows the drive unit efficiency of a low traction fluid of some embodiments relative to that of a comparative fluid.

FIG. 10B shows the drive unit efficiency of a low traction fluid of some embodiments relative to that of a comparative fluid.

FIG. 10C shows the drive unit efficiency of a low traction fluid of some embodiments relative to that of a comparative fluid.

FIG. 10D shows the drive unit efficiency of a low traction fluid of some embodiments relative to that of a comparative fluid.

FIG. 10E shows the drive unit Lambda Ratio comparison of a low traction fluid of some embodiments relative to that of a comparative fluid.

FIG. 10F shows the drive unit Lambda Ratio comparison of a low traction fluid of some embodiments relative to that of a comparative fluid.

FIG. 10G shows the drive unit Lambda Ratio comparison of a low traction fluid of some embodiments relative to that of a comparative fluid.

FIG. 10H shows the drive unit Lambda Ratio comparison of a low traction fluid of some embodiments relative to that of a comparative fluid.

FIG. 11A is an image showing high temperature damage of fluids in some embodiments.

FIG. 11B is an image showing high temperature damage of fluids in some embodiments.

FIG. 11C is an image showing high temperature damage of fluids in some embodiments.

FIG. 11D is an image showing high temperature damage of fluids in some embodiments.

FIG. 12A is a FT-IR spectrum of a comparative fluid before hydrolytic stability testing.

FIG. 12B is an image of a copper corrosion test of a comparative fluid before hydrolytic stability testing.

FIG. 12C is a FT-IR spectrum of a comparative fluid after hydrolytic stability testing.

FIG. 12D is an image of a copper corrosion test of a comparative fluid after hydrolytic stability testing.

FIG. 13A is an image of gear trains utilizing a comparative fluid after fatigue wear testing.

FIG. 13B is an image of gear trains utilizing a comparative fluid after fatigue wear testing.

FIG. 13C is an image of gear trains utilizing a fluid in some embodiments after fatigue wear testing.

FIG. 14A is a graph showing a gearbox fluid system utilizing a fluid in some embodiments at various motor speeds, motor torques and pump rates. X is motor torque, Y is motor speed, and Z (bar) is pump flow rate in LPM.

FIG. 14B is a graph with a 3D coordinate system showing a gearbox fluid system utilizing a fluid in some embodiments at various motor speeds, motor torques and pump rates. X is motor torque, Y is motor speed, and Z (bar) is pump flow rate in LPM.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Embodiments relate to fluid formulations for vehicles (e.g., electric vehicles), in some embodiments, vehicle drive trains. In some embodiments, the fluid formulation is a low traction fluid or a high viscosity coefficient fluid. The fluid formulations of this disclosure may provide higher drive unit (e.g. electric motor and/or gearbox) efficiencies, through the entire drive cycle. In some embodiments, this may be attributed to the low traction fluid formulations providing lower friction and traction through boundary lubrication, mixed lubrication, and/or elastohydrodynamic lubrication regimes. Lower fluid friction and traction may be achieved in some embodiments of flexible fluid designs, for example, such as low traction molecule design coupled with higher viscosity secondary molecules with polarity specifically designed for boundary and mixed lubrication regime friction reduction (i.e., flattening Stribeck curve). The low traction fluid can be designed with improved viscosities, low traction, and boundary and mixed lubrication regime friction reduction. Such low traction fluids allow for improved gear train protection, motor cooling, and drive unit efficiencies.

In some embodiments, the fluid formulation is utilized by the gearbox (e.g., for lubrication and/or cooling) and a second fluid is utilized by the motor (e.g., for cooling and/or lubrication). In some embodiments, the second fluid utilized by the motor is a low traction fluid, a high viscosity coefficient fluid, oil and/or an ultra low viscosity oil. Such a dual fluid lubrication and cooling system design may provide flexibility in fluid design and fluid properties to achieve improved gearbox efficiencies and reliability while simultaneously enhancing the maximum continuous power and efficiency of the motor through lower conductor temperature.

Furthermore, embodiments related to fluids having high pressure viscosity (HPV) coefficient for vehicles (e.g., electric vehicles (EV)) are disclosed herein. Such high pressure viscosity coefficient fluids may help enhance the drive unit efficiency without sacrificing the durability. In some embodiments, the low traction fluid is utilized by a first drive unit (e.g., primary drive unit), and the high pressure viscosity coefficient fluid is utilized by a secondary drive unit. In some embodiments, the secondary drive unit requires lower fluid viscosities and costs while achieving higher efficiencies, which may be achieved by a fluid with higher pressure viscosity coefficient.

The fluid formulation includes a base oil and an additive. In some embodiments, the base oil and/or the additive may be different (e.g., with regard to composition and/or amounts) for the low traction fluid relative to the high pressure viscosity coefficient fluid. In some embodiments, the fluid formulation further includes a Viscosity Index Improver. The fluid formulation may further include elemental impurities.

In some embodiments, the viscosity of the fluid formulation is, is about, is at most, or is at most about, 1 cSt, 2 cSt, 3 cSt, 4 cSt, 5 cSt, 6 cSt, 8 cSt, 10 cSt, 12 cSt, 15 cSt, 20 cSt, 25 cSt, 30 cSt, 35 cSt, 40 cSt or 50 cSt at 100° C., or any range of values therebetween. In some embodiments, the viscosity of the low traction fluid is, is about, is at most, or is at most about, 500 cSt, 550 cSt, 600 cSt, 650 cSt, 700 cSt, 750 cSt, 800 cSt, 900 cSt, 1000 cSt, 1200 cSt, 1500 cSt, 2000 cSt, 2200 cSt or 2500 cSt at −20° C., or any range of values therebetween.

In some embodiments, the traction coefficient of the low traction fluid is, is about, is at most, or is at most about, 0.001, 0.002, 0.003, 0.004, 0.005, 0.006, 0.008, 0.01, 0.015, 0.02, 0.03, 0.04, 0.05, 0.06, 0.07, 0.08, 0.1, 0.15, 0.2 or 0.3, or any range of values therebetween. In some embodiments, the pressure-viscosity coefficient of the low traction fluid is, is about, is at least, or is at least about, 4 gPa⁻¹, 5 Gpa⁻¹, 6 Gpa⁻¹, 7 Gpa⁻¹, 8 Gpa⁻¹, 9 Gpa⁻¹, 10 Gpa⁻¹, 11 Gpa⁻¹, 12 Gpa⁻¹, 13 Gpa⁻¹, 14 Gpa⁻¹, 15 Gpa⁻¹, 16 Gpa⁻¹, 17 Gpa⁻¹, 18 Gpa⁻¹, 19 Gpa⁻¹, 20 Gpa⁻¹, 21 Gpa⁻¹, 22 Gpa⁻¹, 23 Gpa⁻¹, 24 Gpa⁻¹, 25 Gpa⁻¹ or 28 Gpa⁻¹ at 40° C., or any range of values therebetween.

In some embodiments, the traction coefficient of the high pressure viscosity coefficient fluid is, is about, is at most, or is at most about, 0.001, 0.002, 0.003, 0.004, 0.005, 0.006, 0.008, 0.01, 0.015, 0.02, 0.03, 0.04, 0.05, 0.06, 0.07, 0.08, 0.1, 0.15, 0.2, 0.25, 0.3.0.35 or 0.4, or any range of values therebetween. In some embodiments, the traction coefficient of the high pressure viscosity coefficient fluid is higher than that of the low traction fluid disclosed herein. In some embodiments, the pressure-viscosity coefficient of the high pressure viscosity coefficient fluid is, is about, is at least, or is at least about, 8 Gpa⁻¹, 9 Gpa⁻¹, 10 Gpa⁻¹, 11 Gpa⁻¹, 12 Gpa⁻¹, 13 Gpa⁻¹, 14 Gpa⁻¹, 15 Gpa⁻¹, 16 Gpa⁻¹, 17 Gpa⁻¹, 18 Gpa⁻¹, 19 Gpa⁻¹, 20 Gpa⁻¹, 21 Gpa⁻¹, 22 Gpa⁻¹, 23 Gpa⁻¹, 24 Gpa⁻¹, 25 Gpa⁻¹, 26 Gpa⁻¹, 27 Gpa⁻¹, 28 Gpa⁻¹, 29 Gpa⁻¹, 30 Gpa⁻¹, 31 Gpa⁻¹, 32 Gpa⁻¹, 333 Gpa⁻¹, 34 Gpa⁻¹, 35 Gpa⁻¹, 37 Gpa⁻¹, 39 Gpa⁻¹, 40 Gpa⁻¹, 42 Gpa⁻¹, 44 Gpa⁻¹, 46 Gpa⁻¹, 48 Gpa⁻¹ or 50 Gpa⁻¹ at 40° C., or any range of values therebetween.

In some embodiments, the pressure-viscosity coefficient of the high pressure viscosity coefficient fluid is higher than that of the low traction fluid. In some embodiments, the viscosity of the high pressure viscosity coefficient fluid is lower than that of the low traction fluid under the same pressure. In some embodiments, the high pressure viscosity coefficient fluid has a viscosity of, of about, of at least, or of at least about 10%, 12%, 15%, 17%, 20%, 22%, 25%, 27%, 30%, 33%, 35% or 40%, or any range of values therebetween, less than that of a low traction fluid formulation.

In some embodiments, the copper corrosion rating coefficient of the low traction fluid is, or is at most, 1A, 1B, 2A, 2B, 2C, 2D, 2E, 3A, 3B or 4A, or any range of values therebetween. In some embodiments, the ΔTAN of the low traction fluid is, is about, is at most, or is at most about, 0.1 mg KOH/g, 0.2 mg KOH/g, 0.3 mg KOH/g, 0.5 mg KOH/g, 0.8 mg KOH/g, 1 mg KOH/g, 1.5 mg KOH/g, 2 mg KOH/g, 2.5 mg KOH/g, 3 mg KOH/g or 5 mg KOH/g, or any range of values therebetween.

### Base Oil

The fluid formulation (i.e., low traction fluid and/or the high pressure viscosity coefficient fluid) may include at least one base oil. In some embodiments, the base oil is selected from the group consisting of: an American Petroleum Institute (API) group II (“GII”) oil, an API group II+ (“GII+”) oil, an API group III (“GIII”) oil, an API group III+ (“GIII+”) oil, an API group IV (“GIV”) oil, an API group V (“GV”) oil, and combinations thereof. In some embodiments, the GIII+ oil includes a paraffin. In some embodiments, the GIV oil includes a poly-alpha-olefin (PAO). In some embodiments, the GV oil includes at least one of a monoester, a di-ester, an alkylated naphthalene, a polyol ester, and a polyalkylene glycol. In some embodiments, the base oil is selected from the group consisting of: a paraffin, a naphthene, a poly-alpha-olefin (PAO), a monoester, a di-ester, an alkylated naphthalene, a polyol ester, a polyalkylene glycol, and combinations thereof. In some embodiments, the paraffin is selected from the group consisting of: a branched chain paraffin (e.g., iso-paraffin), a straight chain paraffin, a cyclo paraffin, and combinations thereof. Example chemical structures of base oil compounds are shown in Table A herein.

TABLE A
Example Base Oils

| Name | Structure |
|---|---|
| Straight Chain Paraffin | C—C—C—C—C—C—C—C—C—C—C—C—C—C—C—C—C—C—C—C—C—C—C—C |
| (Branched Chain) Iso-Paraffin | 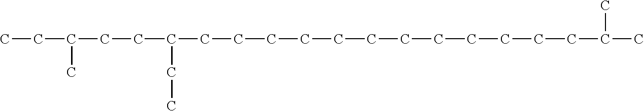 [SMILES: CCC(C)CCC(CC)CCCCCCCCCCCCC(C)C] |
| (Cycloparaffin) Naphthene | 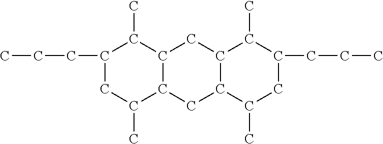 [SMILES: CCCC1CC(C)C2CC3C(C)CC(CCC)C(C)C3CC2C1C] |
| Low Viscosity PAO Dimer | 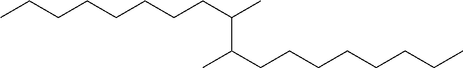 [SMILES: CCCCCCCCC(C)C(C)CCCCCCCC] |
| Low Viscosity PAO Trimer | 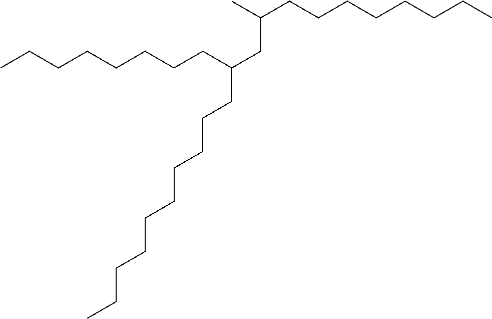 [SMILES: CCCCCCCCCCC(CCCCCCCC)CC(C)CCCCCCCC] |
| Low Viscosity PAO Tetramer | 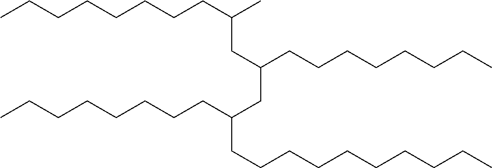 [SMILES: CCCCCCCCCCC(CCCCCCCC)CC(CCCCCCCC)CC(C)CCCCCCCC] |
| High Viscosity PAO | 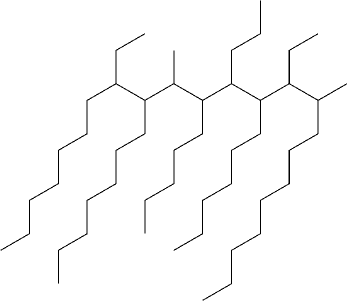 [SMILES: CCCCCCCCC(C)C(CC)C(CCCCCC)C(CCC)C(CCCCC)C(C)C(CCCCCCC)C(CC)CCCCCCC] |
| High Viscosity mPAO | 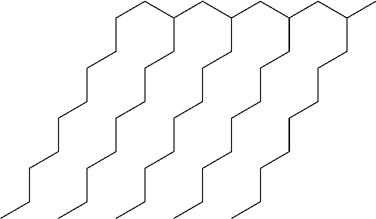 [SMILES: CCCCCCCCCCC(CCCCCCCC)CC(CCCCCCCC)CC(CCCCCCCC)CC(C)CCCCCCCC] |
| Low Viscosity Monoester | 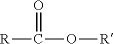 |
| Low Viscosity Diester | 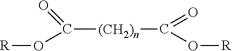 |

In some embodiments, fluid formulation comprises the base oil in, in about, in at least, or in at least about, 50 wt %, 55 wt %, 60 wt. %, 65 wt %, 70 wt. %, 75 wt. %, 80 wt. %, 85 wt. %, 90 wt %, 92 wt. %, 93 wt %, 94 wt. %, 95 wt. %, 96 wt. %, 97 wt % or 98 wt. %, or any range of values therebetween. In some embodiments, the base oil has a viscosity of, of about, of at most, or of at most about, 1.5 cSt, 1.7 cSt, 2 cSt, 5 cSt, 10 cSt, 15 cSt, 20 cSt, 30 cSt, 40 cSt, 50 cSt, 100 cSt, 150 cSt, 200 cSt, 300 cSt, 400 cSt, 500 cSt, 600 cSt, 800 cSt, 1000 cSt, 1200 cSt, 1500 cSt, 1800 cSt, 2000 cSt or 2200 cSt at 100° C., or any range of values therebetween.

In some embodiments, the low traction fluid includes a base oil that comprises a GV ester oil (e.g. monoester, diester or polyol ester), wherein the formulation includes the base oil from 60-85 wt. %, and the base oil has a viscosity of 2.8-6 cSt at 100° C. In some embodiments, the low traction fluid includes a base oil that comprises a GIV oil (e.g. a low viscosity C₈-C₁₆ PAO monomer, wherein the oligomers may be dimers, trimers, and/or tetramers), wherein the formulation includes the base oil from 30-85 wt. %, and the base oil has a viscosity of 1.7-6 cSt at 100° C. In some embodiments, the low traction fluid includes a base oil that comprises a GII+ oil, a GIII oil and/or a GIII+, wherein the formulation includes the total of the base oils from 60-85 wt. %, and wherein the base oil composition has a viscosity of 3-6 cSt at 100° C.

In some embodiments, the low traction fluid includes a base oil that comprises a GIV oil (e.g. PAO), wherein the formulation includes the base oil from 1-50 wt. %, and the base oil has a viscosity of 6-10 cSt at 100° C. In some embodiments, the low traction fluid includes a base oil that comprises a GII+ oil, a GIII oil, and/or a GIII+ oil, wherein the formulation includes the base oil from 1-40 wt. %, and the base oil has a viscosity of 5.5-8 cSt at 100° C.

In some embodiments, the low traction fluid includes a base oil that comprises a GIV oil (e.g. a high viscosity PAO and/or mPAO), wherein the formulation includes the base oil from 1-40 wt. %, and the base oil has a viscosity of 65-300 cSt at 100° C. In some embodiments, the low traction fluid includes a base oil that comprises a GV oil (e.g. a high viscosity ester), wherein the formulation includes the base oil from 0 to 20 wt. %, and the base oil has a viscosity of 125-2000 cSt at 100° C. In some embodiments, the low traction fluid includes a base oil that comprises a GV oil (e.g. a low viscosity ester), wherein the formulation includes the base oil from 1-5 wt. %, and the base oil has a viscosity of 1-6 cSt at 100° C. In some embodiments, the low traction fluid includes a base oil that comprises a GV oil (e.g. an alkylated naphthalene), wherein the formulation includes the base oil from 1-20 wt. %, and the base oil has a viscosity of 5-12 cSt at 100° C.

In some embodiments, the high pressure viscosity coefficient fluid includes a base oil that comprises a GIII base oil, GII+ base oil and a GII base oil. In some embodiments, the pressure viscosity coefficient of the high pressure viscosity coefficient fluid is 15.6 to 19.2 gPa⁻¹ in general operating conditions.

### Additives

The fluid formulation (i.e., low traction fluid and/or high pressure viscosity coefficient fluid) may include at least one additive. In some embodiments, an additive is selected from the group consisting of: an anti-friction additive, an anti-wear additive, an extreme pressure additive, an anti-oxidant, a corrosion inhibitor, a yellow metal deactivator, a dispersant, a detergent, a defoamer, a seal swell agent, a solvency booster, a dye, and combinations thereof. In some embodiments, the formulation comprises the additive in, in about, in at least, or in at least about, 0.001 wt. %, 0.005 wt. %, 0.01 wt. %, %, 0.05 wt. %, 0.1 wt. %, 0.2 wt. %, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, or any range of values therebetween. In some embodiments, the amount of the additives and the base oil totals to about 100 wt %.

Additives include at least one element selected from the group consisting of sulfur, phosphorous, calcium, boron, silicon, nitrogen, and combinations thereof. In some embodiments, the additive includes sulfur in, in about, in at most, or in at most about, 500 ppm, 700 ppm, 800 ppm, 900 ppm, 1000 ppm, 1200 ppm, 1400 ppm, 1600 ppm, 1800 ppm, 2000 ppm, 2200 ppm, 2400 ppm, 2500 ppm, 3000 ppm, 3500 ppm or 4000 ppm, or any range of values therebetween. In some embodiments, the additive includes phosphorous in, in about, in at most, or in at most about, 50 ppm, 60 ppm, 80 ppm, 100 ppm, 120 ppm, 150 ppm, 200 ppm, 250 ppm, 260 ppm, 280 ppm, 300 ppm, 320 ppm, 350 ppm, 400 ppm, 450 ppm, 500 ppm or 600 ppm, or any range of values therebetween. In some embodiments, the additive includes calcium in, in about, in at most, or in at most about, 20 ppm, 30 ppm, 40 ppm, 50 ppm, 60 ppm, 80 ppm, 100 ppm, 120 ppm, 140 ppm, 150 ppm, 160 ppm, 180 ppm, 200 ppm, 250 ppm, 300 ppm or 400 ppm, or any range of values therebetween. In some embodiments, the additive includes boron in, in about, in at most, or in at most about, 10 ppm, 20 ppm, 30 ppm, 40 ppm, 50 ppm, 60 ppm, 70 ppm, 80 ppm, 90 ppm, 100 ppm, 110 ppm, 120 ppm, 140 ppm, 150 ppm or 200 ppm, or any range of values therebetween. In some embodiments, the additive includes silicon in, in about, in at most, or in at most about, 0 ppm, 5 ppm, 10 ppm, 15 ppm, 20 ppm, 25 ppm, 30 ppm, 35 ppm, 40 ppm or 50 ppm, or any range of values therebetween. In some embodiments, the additive includes nitrogen in, in about, in at most, or in at most about, 500 ppm, 600 ppm, 700 ppm, 800 ppm, 900 ppm, 1000 ppm, 1100 ppm, 1200 ppm, 1300 ppm, 1400 ppm, 1500 ppm, 1700 ppm, 2000 ppm or 3000 ppm, or any range of values therebetween.

In some embodiments, the additives comprises an additive formulation selected from HiTEC 3491K, HiTEC 5769, HiTEC 35750, HiTEC 2571, HiTEC 4780, and combinations thereof.

### Viscosity Index Improver

The fluid formulation (i.e., low traction fluid and/or the high pressure viscosity coefficient fluid) may include a viscosity index improver. In some embodiments, formulation comprises the viscosity index improver in, in about, in at most, or in at most about, 0.1 wt. %, 0.2 wt. %, 0.5 wt. %, 0.8 wt. %, 1 wt. %, 2 wt. %, 3 wt. %, 4 wt. %, 5 wt. %, 6 wt. %, 7 wt. %, 8 wt. %, 10 wt. %, 12 wt. %, 14 wt. %, 16 wt. %, 18 wt. %, 20 wt. %, 22 wt. %, 25 wt. % or 30 wt. %, or any range of values therebetween.

In some embodiments, the viscosity of the viscosity index improver is, is about, is at most, or is at most about, 10 cSt, 20 cSt, 30 cSt, 40 cSt, 50 cSt, 100 cSt, 200 cSt, 300 cSt, 500 cSt, 700 cSt, 1000 cSt, 1500 cSt, 2000 cSt, 2500 cSt, 3000 cSt, 4000 cSt, 5000 cSt, 6000 cSt, 8000 cSt, 10000 cSt, 12000 cSt, 14000 cSt, 15000 cSt, 17000 cSt, 19000 cSt, 20000 cSt, 21000 cSt, 22000 cSt, 23000 cSt, 24000 cSt, 25000 cSt, 28000 cSt or 30000 cSt at 100° C., or any range of values therebetween.

### Drive Unit, Vehicle and Use

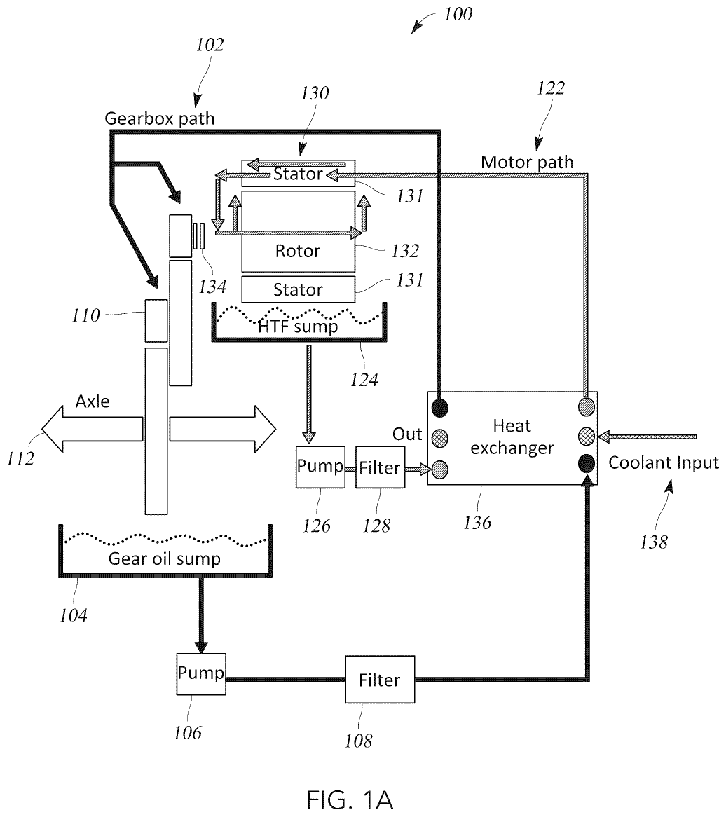

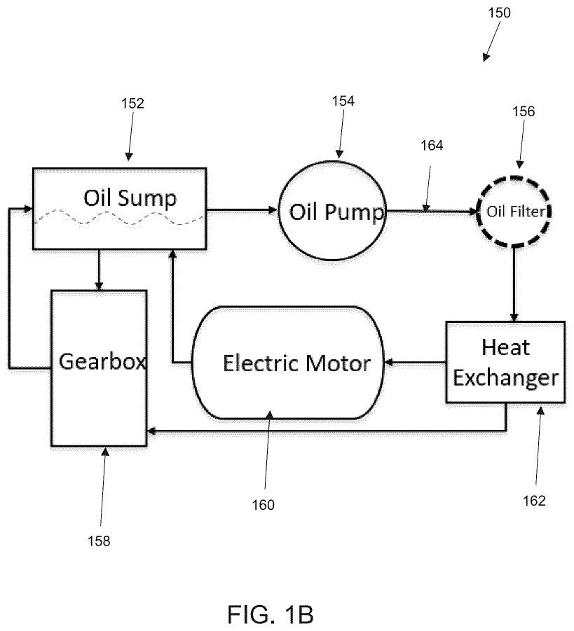

FIG. 1A shows a schematic depiction of dual fluid path system 100, according to some embodiments, comprising a gearbox fluid path 102 and a motor fluid path 122. The gearbox fluid path 102 includes a gear sump 104 comprising a gear fluid in fluid communication with a gearbox pump 106, which passes (e.g. pumps) the gear fluid through a gearbox filter 108 to a heat exchanger 136. The gear fluid from the heat exchanger 136 is then passed to the gear system 110, which returns the gear fluid to the gear sump 104. The gear system 110 is mechanically connected to the axle 112 of a vehicle. The motor fluid path 122 includes a motor sump 124 comprising a motor fluid in fluid communication with a motor pump 126, which passes the motor fluid through a motor filter 128 to a heat exchanger 136. The motor fluid from the heat exchanger 136 is then passed to the motor system 130 comprising stators 131 and a rotor 132, which returns the motor fluid to the motor sump 124. The motor system 130 is mechanically connected to the gear system 110 through connection 134. The heat exchanger 136 comprises a coolant fluid path 138 that flows through the heat exchanger 136 and is configured to exchange heat with the gear fluid and motor fluid.

In some embodiments, at least one of the gear fluid and motor fluid comprise the fluid formulation (i.e., low traction fluid and/or high pressure viscosity fluid). In some embodiment, the gear fluid comprises a first fluid formulation (i.e., low traction fluid or high pressure viscosity fluid), and the motor fluid comprises a second fluid formulation (i.e., low traction fluid or high pressure viscosity fluid). In some embodiments, the gear fluid and motor fluid are different fluid formulations. In some embodiments, the gear fluid and the motor fluid are different low traction fluid formulations. In some embodiments, the gear fluid and the motor fluid are different high pressure viscosity fluid formulations. In some embodiments, one of the gear fluid and the motor fluid is a low traction fluid formulation and the other is a high pressure viscosity fluid formulation. Although a dual oil system is not necessary for enabling low traction fluid or high pressure viscosity fluid design, in some embodiments the dual oil system may provide additional benefits to fluid systems utilizing low traction fluids and/or high pressure viscosity fluids.

FIG. 1B shows a schematic depiction of single fluid path system or single fluid system 150 according to some embodiments, comprising a single fluid path 164. The single fluid path 164 includes an oil sump 152 comprising a fluid in fluid communication with an oil pump 154, which passes the fluid through an oil filter 156 to a heat exchanger 162. The fluid from the heat exchanger 162 is then passed to the gearbox 158, which returns the fluid to the oil sump 152. In the single fluid path 164, the fluid from the heat exchanger 162 is also passed to the motor 160, which returns the fluid to the oil sump 152. The gearbox 158 is mechanically connected to the axle of a vehicle. The motor 160 is mechanically connected to the gearbox 158 through a connection. The heat exchanger 162 may comprise a coolant fluid path that flows through the heat exchanger 162 and is configured to exchange heat with the fluid.

In some embodiments, the gear fluid and/or the motor fluid are a fluid formulation. In some embodiments, the motor fluid is a low viscosity oil for cooling and/or lubrication, which is different from the fluid formulation. In some embodiments, the gear fluid and the motor fluid are the same fluid. In some embodiments, the gear fluid and the motor fluid are low traction fluids. In some embodiments, the gear fluid and the motor fluid are the same low traction fluid formulation or different low traction fluid formulations. In some embodiments, the gear fluid and the motor fluid are high pressure viscosity coefficient fluids. In some embodiments, the gear fluid and the motor fluid are the same high pressure viscosity coefficient fluid formulation or different high pressure viscosity coefficient fluid formulations. In some embodiments, the gear fluid and the motor fluid are different fluids. In some embodiments, the gear fluid is a low traction fluid and the motor fluid is a different fluid. In some embodiments, the gear fluid is a low traction fluid and the motor fluid is a different low traction fluid, a high pressure viscosity fluid, or a low viscosity oil. In some embodiments, the gear fluid is a high pressure viscosity coefficient fluid and the motor fluid is a different fluid. In some embodiments, the gear fluid is a high pressure viscosity coefficient fluid and the motor fluid is a different high pressure viscosity fluid, a low traction fluid, or a low viscosity oil. In some embodiments, the fluid in the single fluid path system is a low traction fluid or a high pressure viscosity coefficient fluid.

In some embodiments, the gearbox fluid system and/or the single fluid system is configured to pump fluid at a rate of, of about, of at least, or of at least about, 0.01 LPM, 0.03 LPM, 0.05 LPM, 0.1 LPM, 0.15 LPM, 0.2 LPM, 0.3 LPM, 0.5 LPM, 1 LPM, 2 LPM, 3 LPM, 4 LPM, 5 LPM, 6 LPM, 7 LPM, 8 LPM, 9 LPM, 10 LPM, 12 LPM, 15 LPM, 18 LPM, 20 LPM, 22 LPM, 25 LPM, 27 LPM, 29 LPM or 30 LPM or any range of values therebetween.

In some embodiments, the vehicle comprises a secondary drive unit in addition to the first drive unit (e.g., primary drive unit). In some embodiments, the secondary drive unit comprises a secondary motor (i.e., a boost motor). In some embodiments, the secondary drive unit comprises a secondary gearbox. In some embodiments, the secondary drive unit comprises a secondary fluid. In some embodiments, the secondary fluid is a secondary fluid formulation. In some embodiments, the secondary fluid formulation is a low traction fluid formulation or a high pressure viscosity fluid formulation. In some embodiments, the secondary fluid formulation is the same fluid formulation as the motor fluid of the first drive unit. In some embodiments, the secondary fluid formulation is the same fluid formulation as the gear fluid of the first drive unit. In some embodiments, the secondary fluid formulation is a different fluid formulation than the motor fluid of the first drive unit. In some embodiments, the motor fluid of the first drive unit is a low traction fluid and the secondary fluid formulation is a different low traction fluid or a high pressure viscosity fluid. In some embodiments, the motor fluid of the first drive unit is a high pressure viscosity fluid, the secondary fluid formulation is a different high pressure viscosity fluid or a low traction fluid. In some embodiments, the secondary fluid formulation is a different fluid formulation than the gearbox fluid of the first drive unit. In some embodiments, the gearbox fluid of the first drive unit is a low traction fluid and the secondary fluid formulation is a different low traction fluid or a high pressure viscosity fluid. In some embodiments, the gearbox fluid of the first drive unit is a high pressure viscosity fluid and the secondary fluid formulation is a different high pressure viscosity fluid or a low traction fluid.

In some embodiments, the secondary fluid is different than the low traction fluid. In some embodiments, the secondary fluid is a high pressure viscosity coefficient fluid, which has a lower viscosity and higher pressure viscosity coefficient relative to the low traction fluid. In some embodiments, utilization of a secondary fluid further increases vehicle efficiencies. In some embodiments, the secondary drive unit utilizes the same low traction fluid as the primary drive unit. In some embodiments, the secondary drive unit does not utilize the low traction fluid. In some embodiments, the secondary drive unit comprises a secondary gearbox fluid path. In some embodiments, the secondary drive unit utilizes the same gearbox fluid path as the primary drive unit. In some embodiments, the secondary drive unit comprises a secondary motor fluid path. In some embodiments, the secondary drive unit utilizes the same motor fluid path as the primary drive unit. In some embodiments, the first drive unit comprises a high pressure viscosity coefficient fluid. In some embodiments, the secondary gearbox fluid system comprises a fluid formulation. In some embodiments, the secondary motor system and secondary gearbox fluid system comprise the same fluid and/or fluid formulation. In some embodiments, the secondary motor system and secondary gearbox fluid system comprise a high pressure viscosity coefficient fluid. In some embodiments, the secondary motor system and secondary gearbox fluid system comprise a low traction fluid. In some embodiments, the secondary motor system and secondary gearbox fluid system comprise different fluids. In some embodiments, the secondary motor system and secondary gearbox fluid system comprise different low traction fluid formulations. In some embodiments, the secondary motor system and secondary gearbox fluid system comprise different high pressure viscosity coefficient fluid formulations. In some embodiments, one of the secondary motor system and secondary gearbox fluid system comprises a low traction fluid formulation and the other comprises a high pressure viscosity coefficient fluid formulation. In some embodiments, the primary drive unit comprises a low traction fluid and the secondary unit comprises a high pressure viscosity coefficient fluid. In some embodiments, the gearbox fluid system of the primary drive unit comprises a low traction fluid and the gearbox fluid system of the secondary drive unit comprises a high pressure viscosity coefficient fluid.

In some embodiments, a vehicle comprises the fluid path system (e.g. single or dual fluid path system). In some embodiments, the vehicle comprises an electric motor. In some embodiments, the vehicle is an electric vehicle. In some embodiment, the vehicle comprises a first drive unit and a secondary drive unit.

### EXAMPLES

Example embodiments of the present disclosure, including processes, materials and/or resultant products, are described in the following examples.

Table B below shows example low traction fluid formulations, which are discussed in the following examples. The amount of the additives and the base oils totals to about 100 wt %.

Table C below shows example high pressure viscosity (HPV) coefficient fluid formulations, which are discussed in the following examples. In some embodiments, the amount of the additives and the base oils totals to about 100 wt %.

TABLE B
Low Traction Fluid Formulations

| | Low Traction | Low Traction | Low Traction | Low Traction | Low Traction |
|---|---|---|---|---|---|
| | Fluid | Fluid | Fluid | Fluid | Fluid |
| Components | Formulation 1 | Formulation 2 | Formulation 3 | Formulation 4 | Formulation 5 |
| Yubase 4+ | — | — | — | — | 0-40% |
| Yubase 3 | — | — | — | — | — |
| Yubase 8 | — | — | — | — | — |
| Prima 60 | — | — | — | — | — |
| Spectrasyn | 70-90% | — | — | 0-48% | 0-40% |
| Max 3.5 | | | | | |
| Low Viscosity | 0-10% | 70-90% | 60-90% | 0-42% | 0-20% |
| GV Base Oil | | | | | |
| PAO | — | 0-10% | — | 0-20% | 0-10% |
| Spectrasyn | 0-10% | — | 0-30% | 0-20% | 0-20% |
| Elite 150 | | | | | |
| Croda 11752 | — | 0-15% | — | 0-5% | — |
| High | 0-15% | 0-5% | 0-5% | 0-5% | 0-15% |
| Viscosity GV | | | | | |
| Base Oil | | | | | |
| Esterex A32 | 0-3% | 0-3% | — | 0-3% | 0-3% |
| Dye | 0-0.05% | 0-0.05% | 0-0.05% | 0-0.05% | 0-0.05% |
| GVII Base | 0-5% | 0-5% | 0-5% | 0-5% | 0-5% |
| Oil | | | | | |
| Additives | 0-12% | 0-12% | 0-12% | 0-12% | 0-12% |
| (HiTEC | | | | | |
| 3491K) | | | | | |
| Additional | 0-10% | 0-10% | 0-10% | 0-10% | 0-10% |
| Additives | | | | | |

TABLE C
High Pressure Viscosity (HPV) Coefficient Fluid Formulations

| | HPV | HPV | HPV | HPV |
|---|---|---|---|---|
| Components | Formulation 1 | Formulation 2 | Formulation 3 | Formulation 4 |
| Yubase 4+ | — | — | — | — |
| Yubase 3 | 75-85% | — | 0-60% | 0-20% |
| Yubase 8 | 0-10% | 30-40% | 0-10% | 0-20% |
| Prima 60 | — | 50-60% | 0-60% | 0-20% |
| Spectrasyn | — | — | — | 0-30% |
| Max 3.5 | | | | |
| Low Viscosity | — | — | — | 0-30% |
| GV Base Oil | | | | |
| PAO | — | — | 0-10% | 0-10% |
| Spectrasyn | — | — | 0-20% | 0-20% |
| Elite 150 | | | | |
| Croda 11752 | — | — | — | — |
| High | — | — | — | 0-5% |
| Viscosity GV | | | | |
| Base Oil | | | | |
| Esterex A32 | 0-3% | 0-3% | 0-3% | 0-3% |
| Dye | 0-0.05% | 0-0.05% | 0-0.05% | 0-0.05% |
| GVII Base | 0-11% | 0-3% | 0-3% | 0-3% |
| Oil | | | | |
| Additives | 0-12% | 0-12% | 0-12% | 0-12% |
| (HiTEC | | | | |
| 3491K) | | | | |
| Additional | 0-10% | 0-10% | 0-10% | 0-10% |
| Additives | | | | |

### Example 1

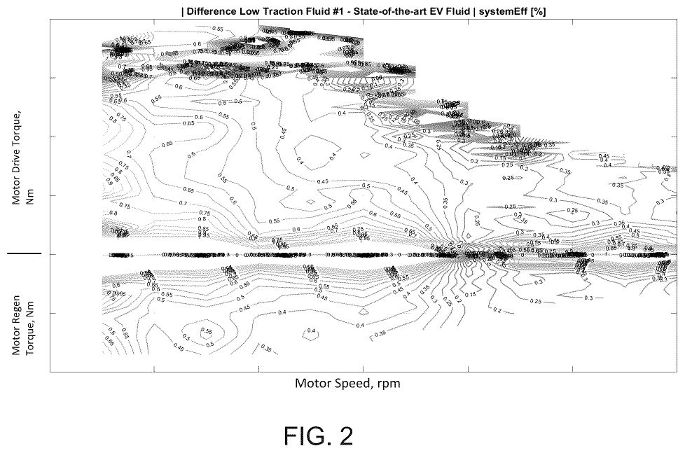

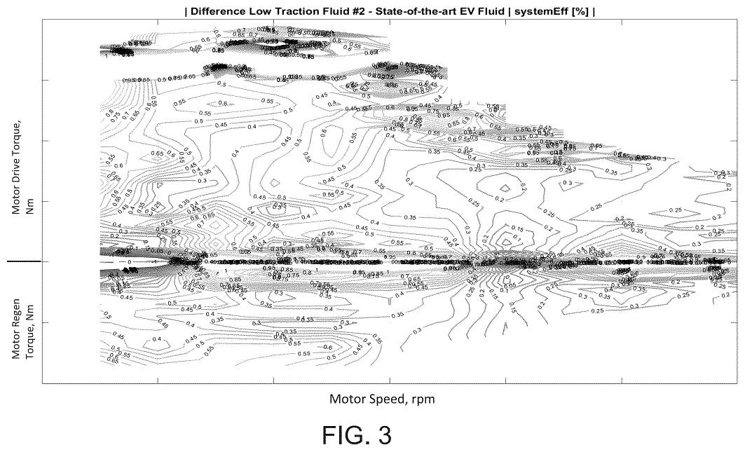

FIGS. 2 and 3 show drive unit efficiency enhancements utilizing low traction fluid formulations described herein. FIG. 2 shows the drive unit efficiency enhancements of Low Traction Fluid Formulation 1 relative a Comparative Formulation 1, where it is shown that Low Traction Fluid Formulation 1 demonstrated a 0.3% to 0.8% efficiency gain in most areas and a 0.3% to 0.6% efficiency gain in most of operating areas relative to Comparative Formulation 1. FIG. 3 shows the drive unit efficiency enhancements of Low Traction Fluid Formulation 2 relative a Comparative Formulation 1, where it is shown that Low Traction Fluid Formulation 2 demonstrated a 0.2% to 0.8% efficiency gain in most areas and a 0.2% to 0.6% efficiency gain in most of operating areas.

### Example 2

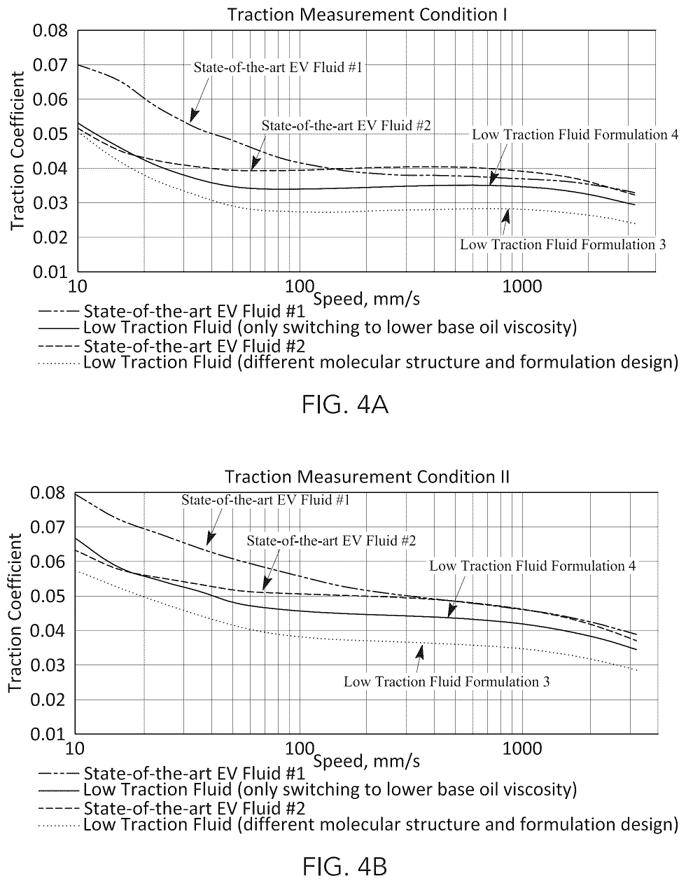

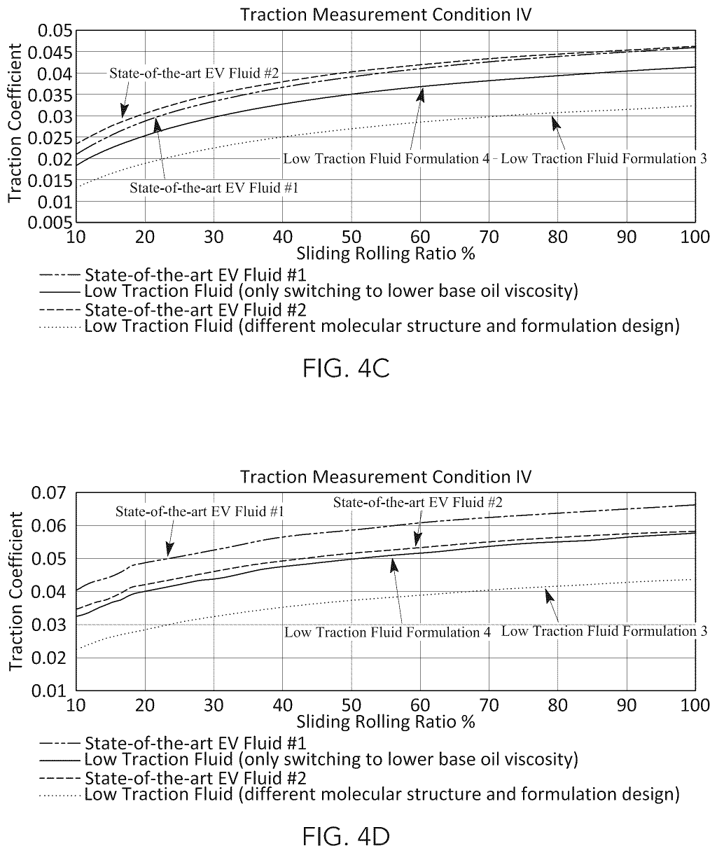

FIGS. 4A-4D show traction coefficients at various speeds, loads, and sliding to rolling ratios of a Low Traction Fluid Formulation 4 (i.e., labeled “Low Traction Fluid (only switching to lower base oil viscosity)”), Low Traction Fluid Formulation 3 (i.e., labeled “Low Traction Fluid (different molecular structure and formulation design”), Comparative Formulation 1 (i.e., labeled “State-of-the-art EV Fluid #1”), and Comparative Formulation 2 (i.e., labeled “State-of-the-art EV Fluid #2”) under different speed, load, and sliding to rolling ratio measurement conditions. Relative to the comparative examples, Formulations 3 and 4 of the low traction fluid showed about a 30-50% traction reduction depending on the various conditions, which would directly lead to drive unit efficiency enhancements. Traction coefficients ranged from below 0.005, in the low sliding to rolling ratio area, to below 0.06, in the high sliding to rolling ratio and low Lambda ratio area. Formulations 3 and 4 of the low traction fluid showed lower traction in all tested conditions and all drive unit spec points, with traction coefficients lower than Comparative Formulations 1 and 2.

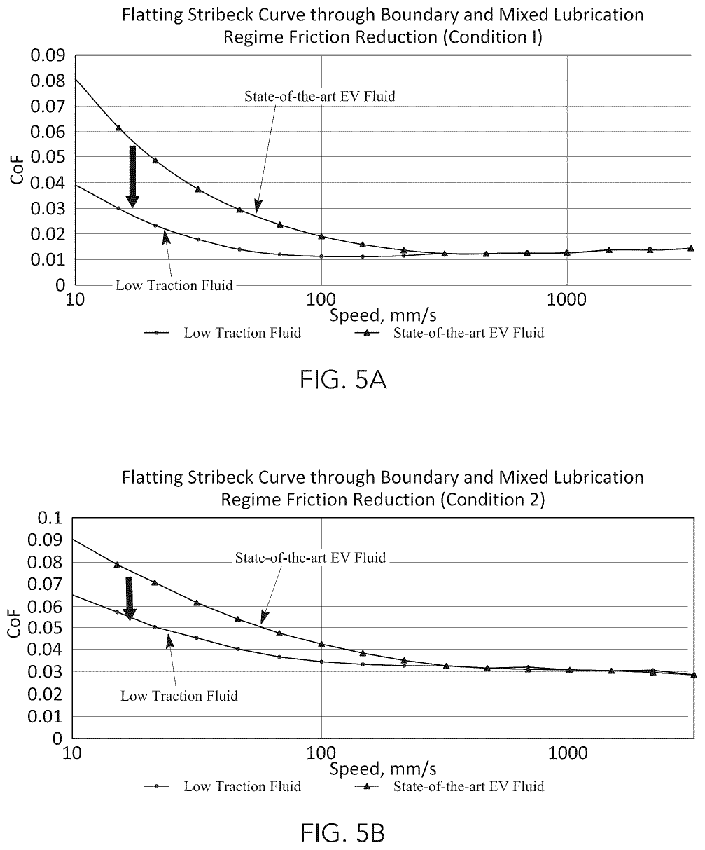

FIGS. 5A and 5B show traction coefficients at various speeds and loads of Low Traction Fluid Formulation 1 (i.e., labeled “Low Traction Fluid”), and Comparative Formulation 3 (i.e., labeled “State-of-the-art EV Fluid”) under different speed and load measurement conditions. Low Traction Fluid Formulation 3 comprises a secondary base oil and additive systems, and showed an about 30-50% reduction under boundary and mixed lubrication relative to Comparative Formulation 3.

### Example 3

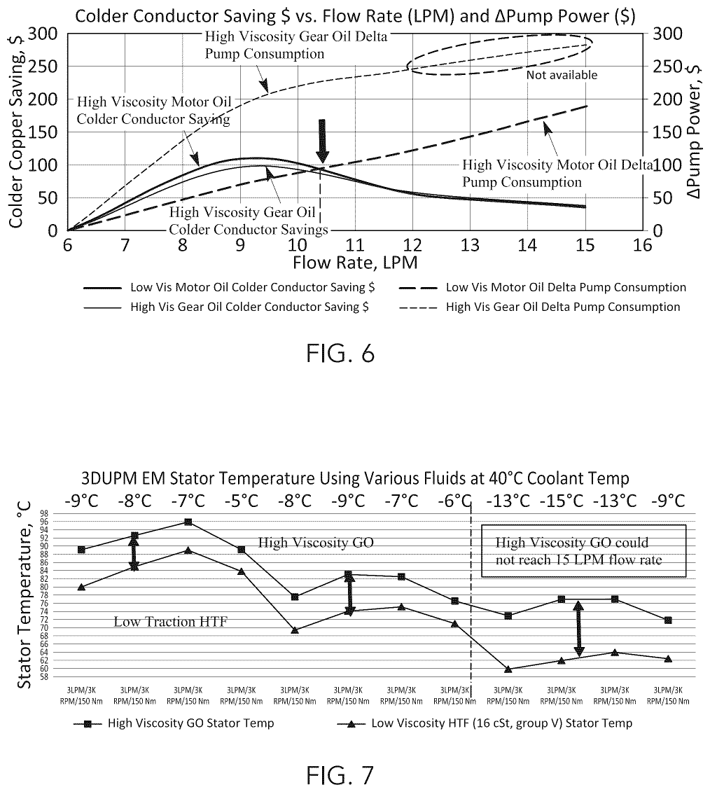

FIG. 6 shows pump power consumption and colder copper saving of a dual fluid path system when a low traction fluid formulation is used in combination with a low viscosity heat transfer fluid (HTF) (i.e., labeled “Low Vis Motor Oil”) compared to a high viscosity gear oil (i.e. labeled “High Vis Gear Oil”) at various flow rates. The low viscosity HTF in combination with the low traction gearbox fluid was shown to provide a lower conductor temperature (i.e. higher continuous power) and lower pump power consumption through a dual oil design. For example, the low viscosity HTF under highway cruising condition (8000 rpm and 150 Nm) at pump rate above 10.3 LPM demonstrated that the pump power consumption outweighed the colder copper saving. In addition, the low viscosity HTF in combination with the low traction gearbox fluid demonstrated a pump power consumption of less than half of the high viscosity gear oil, wherein the high viscosity gear oil with a viscosity of 83 cSt demonstrated that the pump power consumption outweighed colder copper saving between 6 to 9 LPM.

FIG. 7 shows a motor dyno study of stator temperatures of a dual fluid path system that utilizes a low traction gearbox fluid in combination with a low viscosity HTF (16 cSt). Compared to high viscosity gear oil, low viscosity HTF (⅕ of gear oil in viscosity) showed a 5-15° C. copper temperature drop. In addition, the high viscosity gear oil could not reach 15 LPM flow rate.

### Example 4

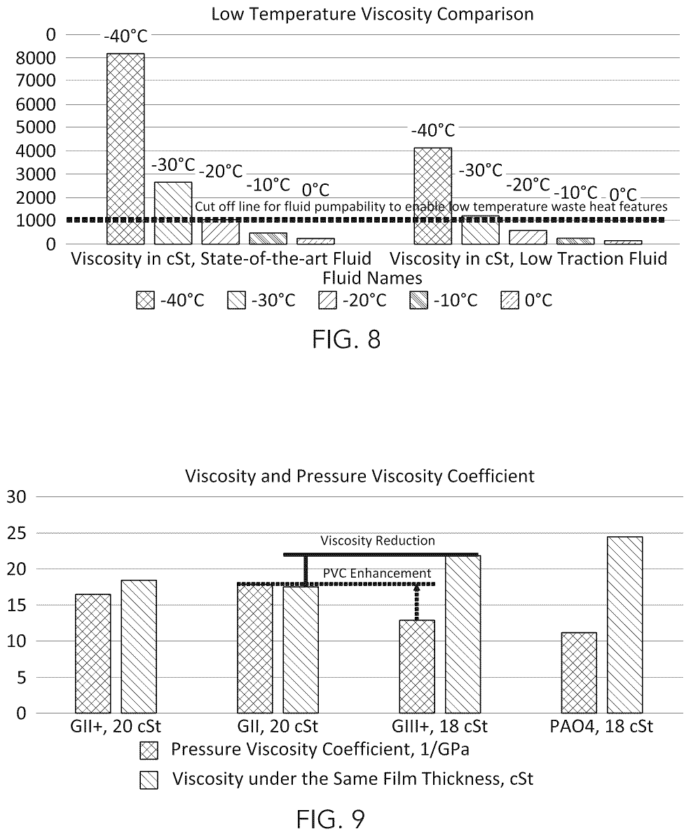

FIG. 8 shows the viscosities for Low Traction Fluid Formulation 1 compared to a comparative gear oil fluid (i.e., labeled “State-of-the-art Fluid”) at low temperatures. Low Traction Fluid Formulation 1 is shown to enable waste heat features (for battery warming) at about 7-10° C. lower than the State-of-the-art Fluid. In addition, Low Traction Fluid Formulation 1 is also shown to increase vehicle range at low temperature due at least in part to decreased viscosity. In contrast, the State-of-the-art Fluid cannot be used at temperatures below −5° C.

### Example 5

FIG. 9 shows the viscosities and pressure viscosity coefficients (PVCs) for low viscosity, high pressure viscosity coefficient fluids, which are designed for a secondary drive unit for the purpose of higher vehicle efficiencies, with a GIII base oil, GII+ base oil and a GII base oil, compared to comparative fluid formulations with a GIII+ base oil and a GIV (i.e., PAO4) base oil. As demonstrated, comparative fluid formulations have a PVC ranging from about 11.8-13.3 gPa⁻¹ in general operating conditions. In contrast, the low viscosity high PVC fluids have PVCs ranging from 15.6 to 19.2 Gpa⁻¹ in general operating conditions. As a comparison, low traction primary fluids described herein may have a PVC of 11.8 to 12.5 Gpa⁻¹ in general operating conditions. As such, the low viscosity high PVC fluids are demonstrated to provide about a 33% PVC enhancement relative to the comparative fluid formulations. Such an improved PVC may bring a viscosity reduction of about 20%, which would reduce the parasitic loss when used in a boost motor of a secondary drive unit. HPV Formulations 1 and 2 are additional examples of such low viscosity high PVC fluids.

### Example 6

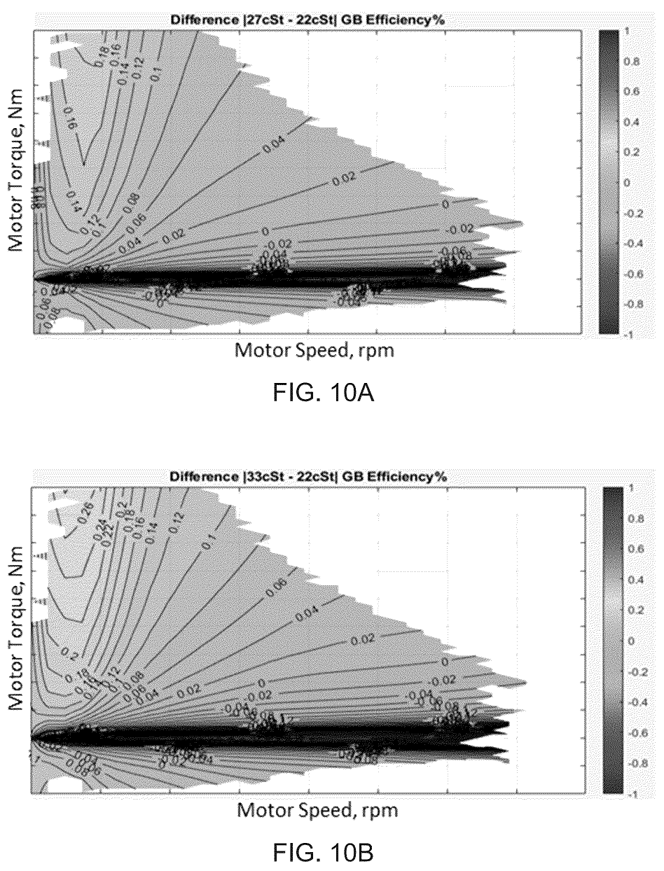

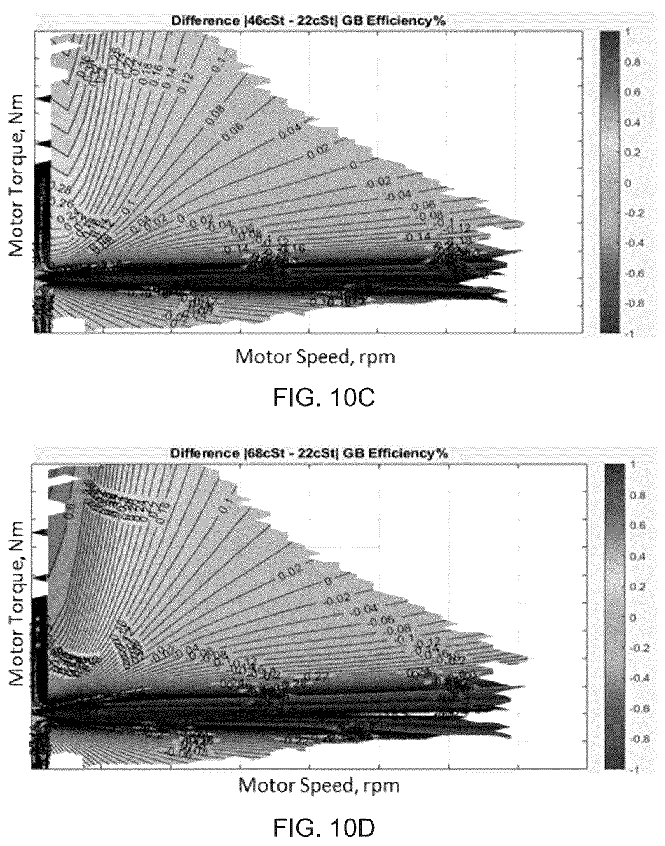

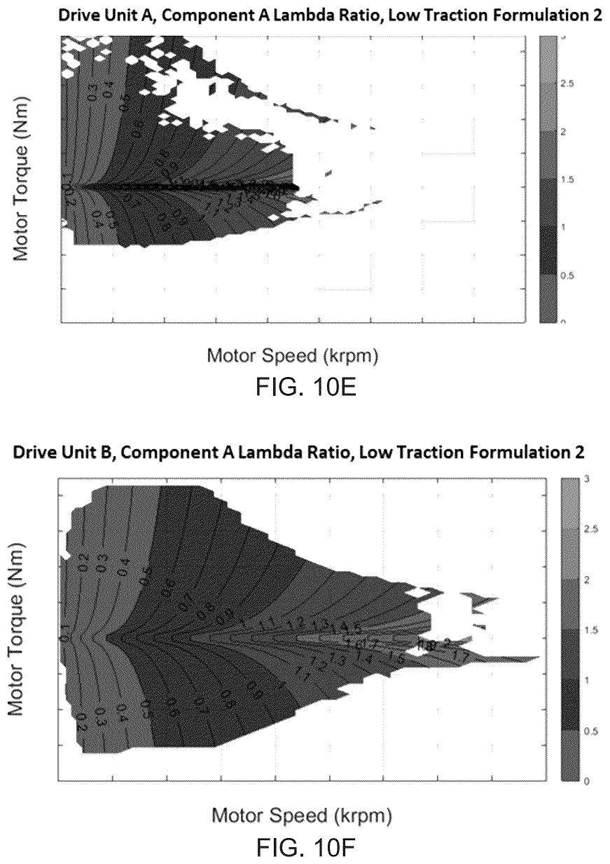

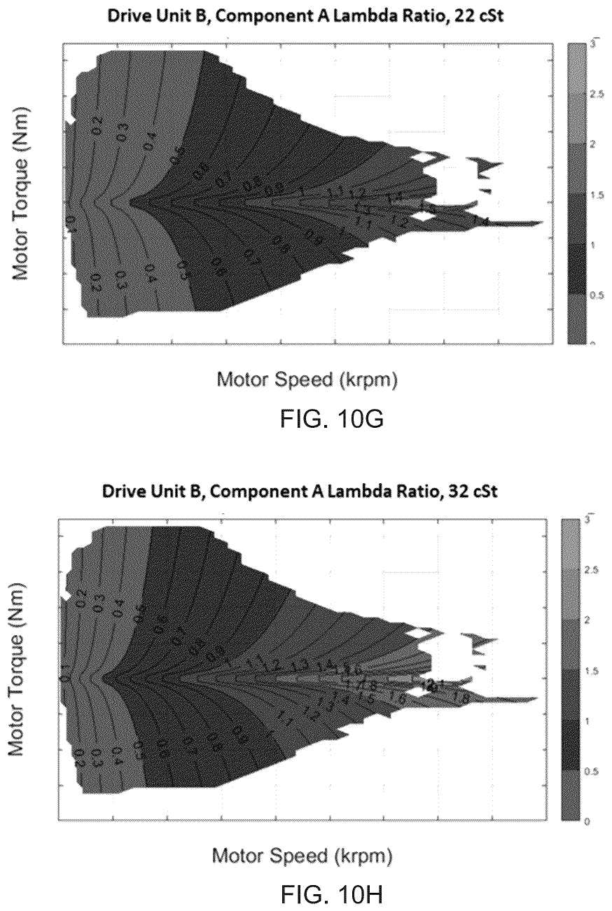

FIGS. 10A-10D show the drive unit efficiency of a 27 cSt (FIG. 10A), a 33 cSt (FIG. 10B), a 46 cSt (FIG. 10C) and a 68 cSt (FIG. 10D) low traction fluid formulations relative to that of a 22 cSt comparative low traction fluid formulation. Low traction fluids with 27 and 33 cSt demonstrated the most improvements in the drive units tested herein with regard to efficiency and durability.

FIGS. 10E-10H show the drive unit Lambda Ratio (related to lubrication related component life) of Low Traction Formulation 2 in Drive Unit A, Low Traction Formulation 2 in Drive Unit B, a 22 cSt low traction fluid formulation in Drive Unit B, and a 32 cSt low traction fluid formulation in Drive Unit B, respectively. As illustrated in FIGS. 10E-10H, the various drive unit components cover a wide range of lubrication conditions.

### Example 7

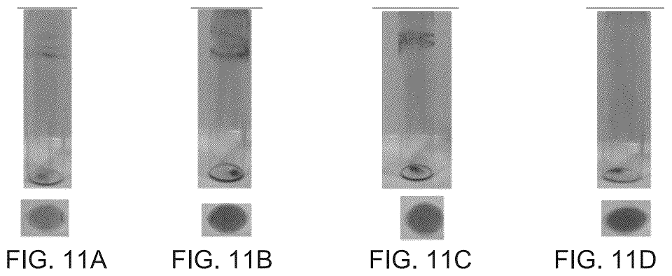

The high temperature fluid degradation resistance of the low traction fluid and comparative fluid formulations were tested. The temperature damage test simulation was performed using accelerated testing to emulate in 1 million miles of use. The testing parameters were according to CEC L-48-00, where the fluids were tested for 600 hrs, at 150° C. and a 5 L/hr air flow rate, with 100 mL of fluid. The results of the temperature damage test simulation are shown in Table 1 herein, where it is seen that the Formulation 1 low traction fluid outperformed Comparative Formulations 1 and 2. FIGS. 11A-11D show images of high temperature damage of the Formulation 1 low traction fluid over time in accelerated testing.

TABLE 1
High Temperature Fluid Degradation Resistance

| | Specification | Comparative | Comparative | |
|---|---|---|---|---|
| Properties | Requirement | Formulation 1 | Formulation 2 | Formulation 1 |
| ΔKV at | 10% max. | +4.79% | +14.18% | +7.94% |
| 40° C., | | | | |
| ASTM D445 | | | | |
| ΔKV at | 10% max. | +4.26% | +11.68% | +6.10% |
| 100° C., | | | | |
| ASTM D445 | | | | |
| Peak Area | Report | 36.2 | 73.7 | 44.1 |
| Increase | | | | |
| (PAI) | | | | |
| ΔTAN¹ (mg | 2 max. | 0.8 | 1.3 | 1.2 |
| KOH/g), 2 | | | | |
| max., ASTM | | | | |
| D664 | | | | |
| Sludge Rating | No sludge | No sludge | No sludge | No sludge |
| of Flask, | | | | |
| Report | | | | |

¹ΔTAN = Change in total acid number

### Example 8

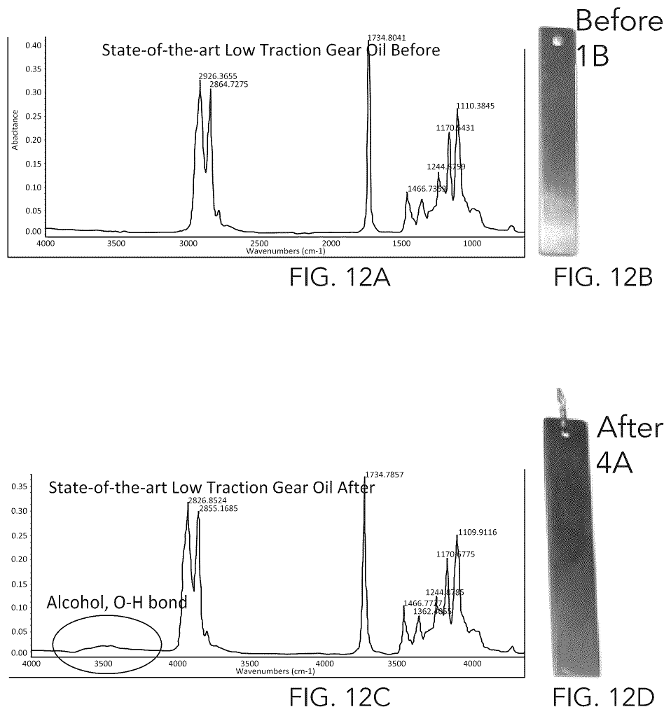

The hydrolytic stability of the low traction fluid formulation and comparative fluid formulations were tested. Hydrolytic stability testing may be necessary to validate longevity of certain base oils (e.g. GV base oils, such as synthetic polyalkylene glycols and high polarity esters), as some base oils may have favorable low traction properties but may not be suitable for lubrication and cooling applications due to high hygroscopicity. Such hygroscopic base oils may be prone to be hydrolyzed that may necessitate an early oil change or trigger a component failure. Hydrolytic stability was tested with 250 ml of testing fluid continuously agitated with 25 mL of distilled water at 90° C. for 192 hours, and the results of Comparative Formulations 1-3 and Formulation 1 are shown in Table 2 herein. FIGS. 12A and 12B show the FT-IR spectrum and a copper corrosion test image, respectively, of Comparative Formulation 3 before hydrolytic stability testing, and FIGS. 12C and 12D show the FT-IR spectrum and a copper corrosion test image, respectively, of Comparative Formulation 3 after hydrolytic stability testing. Table 2 and FIGS. 12A-12B demonstrate that Comparative Formulations 1-3 absorb water, while the Formulation 1 low traction fluid show improved hydrolytic stability.

TABLE 2
Hydrolytic Stability

| | Specification | Comparative | Comparative | Comparative | Low Traction |
|---|---|---|---|---|---|
| Properties | Requirement | Formulation 1 | Formulation 2 | Formulation 3 | Formulation 1 |
| ΔKV at 40° C., | 10% max. | — | — | +15.92% | — |
| ASTM D445 | | | | | |
| ΔKV at 100° C., | 10% max. | — | — | +20.50% | — |
| ASTM D445 | | | | | |
| Copper | 3A max. | 1B to 2C | 1B to 2A | 1B to 4A | 1B to 1B |
| Corrosion | | | | | |
| Rating, ASTM | | | | | |
| D130 | | | | | |
| ΔTAN (mg | 2 max. | 1.1 | 0.1 | 15.25 | 0.06 |
| KOH/g), 2 | | | | | |
| max., ASTM | | | | | |
| D664 | | | | | |

### Example 9

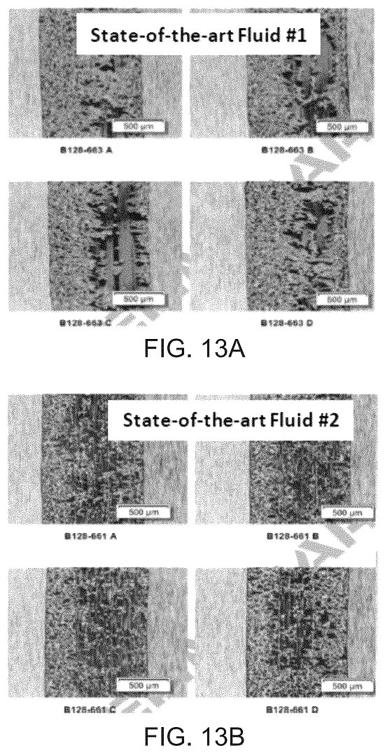

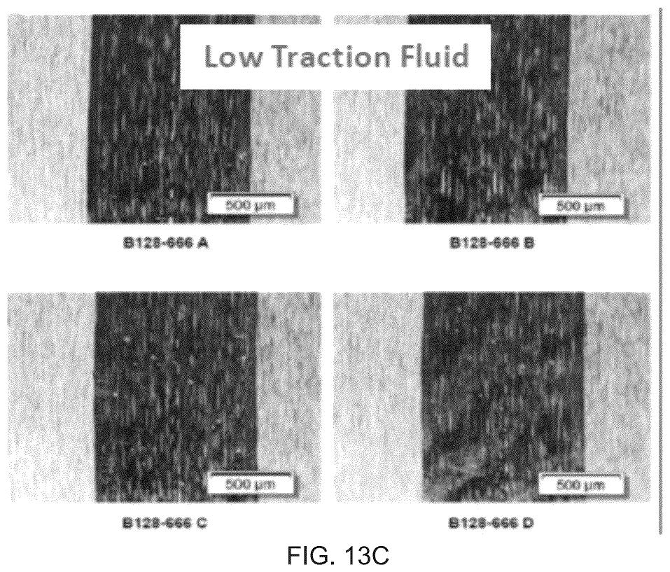

The gear train fatigue wear protection for Low Traction Formulation 1 and comparative fluid formulations were tested. Fatigue of gear trains may result in macropitting (“pitting”) (i.e., large pits that form on the surfaces in contact, that may result from surface or subsurface initiated cracks propagating into large scale pits), micropitting (i.e., microscopic pits that form on the surfaces in contact, that may be produced by asperity scale plastic flow caused by repeated cyclic contact stresses with pits are typically <100 microns wide and can be identified by microscope or weight loss), and gear scuffing (i.e., localized damage of a surface, often referred to as scuffing, that may be formed by compromised lubricant film strength at high load conditions and high sliding velocities). Furthermore, as gear teeth engage and disengage under such conditions, welding and tearing may occur, respectively. Pitting and micropitting of Formulation 1 of the low traction fluid and Comparative Formulations 1 and 2 were evaluated in a gear train under 400 N, at 60° C., run at 3.5 m/s (5570 rpm), and 20% sliding to rolling ratio, and the results are shown in Table 3. FIGS. 13A-13C show images of gear trains utilizing Comparative Formulation 1, Comparative Formulation 2 and Formulation 1 of the low traction fluid, respectively, after fatigue wear testing.

TABLE 3
Fatigue Wear Protection

| | | | Wear |
|---|---|---|---|
| Fluid Types | Cycles, 10\hat{ }6 | Friction | Loss |
| Comparative | 22 | 0.070 | 1.8 |
| Formulation 1 | | | |
| Comparative | 30 (did not fail) | 0.055 | 0.5 |
| Formulation 2 | | | |
| Formulation 1 | 30 (did not fail) | 0.045 | 0.2 |

### Example 10

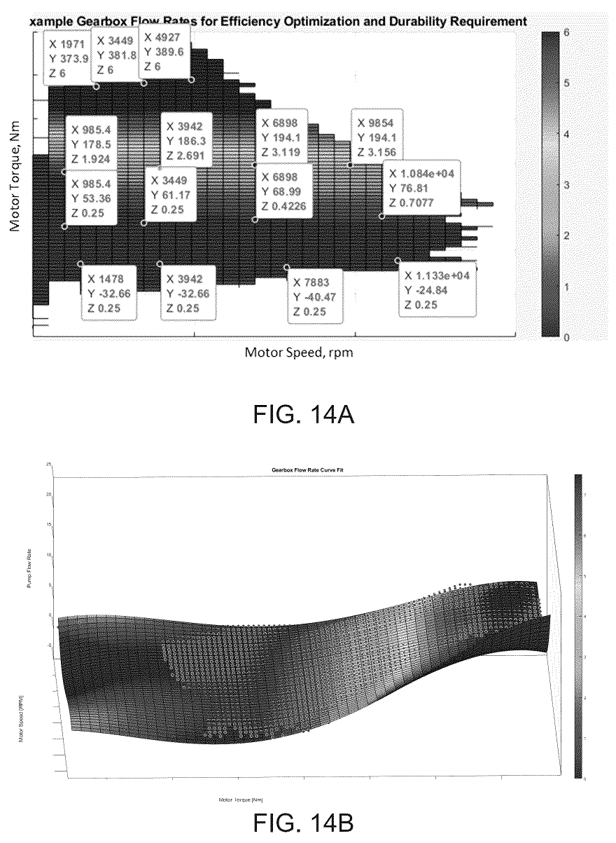

FIG. 14A is a graph showing a gearbox fluid system utilizing a low traction fluid formulation at various motor speeds, motor torques and pump rates. X is motor speed, Y is motor torque, and Z (bar) is pump flow rate in LPM.

FIG. 14B is a graph plotted in a 3D coordinate system showing a gearbox fluid system utilizing a low traction fluid formulation at various motor speeds, motor torques and pump rates with the same data in FIG. 14A. X is motor torque, Y is motor speed, and Z (bar) is pump flow rate in LPM. FIGS. 14A and 14B demonstrate that the low traction fluid formulation is coupled with flexible pump flow rates for gearbox lubrication to further achieve efficiency improvements, with pump flow rates are ranging from 0.25 LPM to 20 LPM for efficiency and durability requirements, depending on the applications.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

1. A fluid formulation, comprising:
an additive; and
a base oil, wherein the base oil is selected from the group consisting of an American Petroleum Institute (API) group II oil, an API group II+ oil, an API group III oil, an API group III+ oil, an API group IV oil, an API group V oil, and combinations thereof.

2. The fluid formulation of claim 1, wherein the base oil is selected from the group consisting of a paraffin, a naphthene, a poly-alpha-olefin (PAO), a monoester, a di-ester, an alkylated naphthalene, a polyol ester, a polyalkylene glycol, and combinations thereof.

3. The fluid formulation of claim 2, wherein the paraffin is selected from the group consisting of an iso-paraffin, a straight chain paraffin, a cyclo paraffin, and combinations thereof.

4. The fluid formulation of claim 1, wherein the fluid formulation comprises about 70-95 wt. % of the base oil.

5. The fluid formulation of claim 1, wherein the base oil comprises a viscosity of 1.7-2000 cSt at 100° C.

6. The fluid formulation of claim 1, wherein the additive is selected from the group consisting of: an anti-friction additive, an anti-wear additive, an extreme pressure additive, an anti-oxidant, a corrosion inhibitor, a yellow metal deactivator, a dispersant, a detergent, a defoamer, a seal swell agent, a solvency booster, a dye, and combinations thereof.

7. The fluid formulation of claim 1, wherein the additive comprises at least one element selected from the group consisting of sulfur, phosphorous, calcium, boron, silicon, nitrogen, and combinations thereof.

8. The fluid formulation of claim 1, wherein the additive comprises an additive formulation selected from the group consisting of HiTEC 3491K, HiTEC 5769, HiTEC 35750, HiTEC 2571, HiTEC 4780, and combinations thereof.

9. The fluid formulation of claim 1, wherein the fluid formulation comprises about 5-15 wt. % of the additive.

10. The fluid formulation of claim 1, further comprising a viscosity index improver.

11. The fluid formulation of claim 10, wherein the fluid formulation comprises about 1-20 wt. % of the viscosity index improver.

12. The fluid formulation of claim 10, wherein the viscosity index improver comprises a viscosity of about 40-20000 cSt at 100° C.

13. The fluid formulation of claim 1, wherein a viscosity of the fluid formulation is about 2-30 cSt at 100° C.

14. The fluid formulation of claim 1, wherein a viscosity of formulation is about 300-20000 cSt at −20° C.

15. The fluid formulation of claim 1, wherein the fluid formulation is a low traction fluid formulation.

16. The fluid formulation of claim 15, wherein a traction coefficient of the low traction fluid formulation is about 0.005-0.06.

17. The fluid formulation of claim 15, wherein a pressure-viscosity coefficient of the low traction fluid formulation is about 10-20 GPa⁻¹ at 40° C.

18. The fluid formulation of claim 1, wherein the fluid formulation is a high pressure viscosity coefficient fluid formulation.

19. The fluid formulation of claim 18, wherein a traction coefficient of the high pressure viscosity coefficient fluid formulation is about 0.005-0.15.

20. The fluid formulation of claim 18, wherein a pressure-viscosity coefficient of the high pressure viscosity coefficient fluid formulation is about 12-30 GPa⁻¹ at 40° C.

21. A vehicle drive unit, comprising:
a motor;
a motor fluid system in fluid communication with the motor;
a gearbox; and
a gearbox fluid system in fluid communication with the gearbox, wherein the gearbox fluid system comprises the fluid formulation of claim 1.

22. The vehicle drive unit of claim 21, wherein the gearbox fluid system is configured to pump fluid at a rate of about 0.2-20 LPM.

23. The vehicle drive unit of claim 21, wherein the motor fluid system is in fluid communication with the gearbox fluid system.

24. The vehicle drive unit of any one of claim 21, wherein the motor fluid system comprises the fluid formulation.

25. The vehicle drive unit of any one of claim 21, wherein the motor fluid system comprises a motor fluid formulation.

26. The vehicle drive unit of claim 25, wherein the motor fluid formulation is a low traction fluid formulation or a high pressure viscosity coefficient motor fluid formulation.

27. The vehicle drive unit of claim 21, wherein the motor is an electric motor.

28. A vehicle comprising the vehicle drive unit of claim 21.

29. The vehicle of claim 28, wherein the vehicle further comprises a secondary drive unit comprising a secondary fluid formulation.

30. The vehicle of claim 29, wherein the secondary fluid formulation comprises a secondary low traction fluid formulation or a secondary high pressure viscosity coefficient fluid formulation.

31. The vehicle of claim 29, wherein the gearbox fluid system of the drive unit comprises a low traction fluid formulation and the secondary drive unit comprises a secondary high pressure viscosity coefficient fluid formulation.

32. A method of using a vehicle drive unit, comprising:
providing a vehicle drive unit comprising:
a motor;
a motor fluid system in fluid communication with the motor;
a gearbox; and
a gearbox fluid path system in fluid communication with the gearbox, wherein the gearbox fluid path system comprises the fluid formulation of claim 1; and
flowing the fluid formulation through the gearbox and the gearbox fluid system.
